(19) United States
(12) Patent Application Publication
(10) Pub. No.: US 2025/0092857 A1
(43) Pub. Date: Mar. 20, 2025

(54) FLOATING WIND TURBINE PLATFORM

(71) Applicant: University of Maine System Board of Trustees, Orono, ME (US)

(72) Inventors: Habib J. Dagher, Veazie, ME (US); Anthony M. Viselli, Bangor, ME (US)

(73) Assignee: University of Maine System Board of Trustees, Orono, ME (US)

(21) Appl. No.: 18/580,357

(22) PCT Filed: Jul. 25, 2022
(86) PCT No.: PCT/US2022/038161

§ 371 Date: Jan. 18, 2024

Related U.S. Application Data
(60) Provisional application No. 63/224,988, filed on Jul. 23, 2021.

(51) Int. Cl. F03D 13/25; B63B 35/44

(52) U.S. Cl. CPC F03D 13/25; B63B 35/44; B63B 2035/446; F05B 2240/95

(57) ABSTRACT

A semi-submersible wind turbine platform is configured for floating in a body of water and supporting a wind turbine, and includes a center column, at least three tubular bottom beams extending radially outward of a first axial end of the center column, the center column configured to have a tower attached to a second axial end thereof, outer columns, wherein a first axial end of each outer column attached to a distal end of one of the bottom beams, and top beams, one of which extends between a second axial end of each outer column and the second axial end of the center column.

### BACKGROUND

This invention relates in general to floating platforms. In particular, this invention relates to embodiments of improved floating offshore wind turbine (FOWT) platforms that have a lower weight and are easier to manufacture and assemble than known FOWT platforms.

Wind turbines for converting wind energy to electrical power are known and provide an alternative energy source for power companies. On land, large groups of wind turbines, often numbering in the hundreds of wind turbines, may be placed together in one geographic area. Siting these large groups of wind turbines may have limitations near dense population centers if they generate undesirably high levels of noise, or they may be viewed as aesthetically unpleasing. An optimum wind resource may not be available to these land-base wind turbines due to obstacles such as hills, woods, and buildings.

Groups of wind turbines may also be located offshore, but near the coast at locations where water depths allow the wind turbines to be fixedly attached to a foundation on the seabed. Over the ocean, the flow of air to the wind turbines is not likely to be disturbed by the presence of various obstacles (i.e., as hills, woods, and buildings) resulting in higher mean wind speeds and more power. The foundations required to attach wind turbines to the seabed at these near-coast locations can be accomplished at relatively shallow depths, such as a depth of up to about 45 meters.

The U.S. National Renewable Energy Laboratory has determined that winds off the U.S. Coastline over water having depths of 30 meters or greater have an energy capacity of about 3,200 TWh/yr. This is equivalent to about 90 percent of the total U.S. energy use of about 3,500 TWh/yr. The majority of the offshore wind resource resides between 37 and 93 kilometers offshore where the water is over 60 meters deep. Fixed foundations for wind turbines in such deep water are not likely economically feasible. This limitation has led to the development of floating platforms for wind turbines. Known floating wind turbine platforms may be anchored to the seabed with mooring lines and provide some stability to the tower and turbine against external loading from wind, waves, and current, as well as loading associated with the dynamics of the wind turbine mounted thereon.

Some known FOWT platforms may be formed from steel and are based on technology developed by the offshore oil and gas industry. Other known FOWT platforms may include components formed from pre-stressed or reinforced concrete, FRP, steel, or combinations of pre-stressed reinforced concrete, FRP, and steel. There remains however, a need to provide an improved FOWT platform particularly with the ever increasing size of potential turbines which have reached 15 MW and may be larger.

### SUMMARY

This application describes various embodiments of an improved FOWT platform. In one embodiment, a semi-submersible wind turbine platform is capable of floating on a body of water and supporting a wind turbine, and includes a center column, at least three tubular bottom beams extending radially outward of a first axial end of the center column, the center column configured to have a tower attached to a second axial end thereof, outer columns, wherein a first axial end of each outer column attached to a distal end of one of the bottom beams, and top beams, one of which extends between a second axial end of each outer column and the second axial end of the center column.

Various advantages of the invention will become apparent to those skilled in the art from the following detailed description, when read in view of the accompanying drawings.

### BRIEF DESCRIPTION OF THE DRAWINGS

FIG. 1 is a perspective view of a known FOWT platform.

FIG. 2 is an elevational view of the FOWT platform illustrated in FIG. 1.

FIG. 3 is a top plan view of the FOWT platform illustrated in FIG. 1.

FIG. 4 is a perspective view of a first embodiment of an improved FOWT platform in accordance with this invention.

FIG. 5 is a top plan view of the FOWT platform illustrated in FIG. 4 shown without the wind turbine and the wind turbine tower.

FIG. 6 is an elevational view of the FOWT platform illustrated in FIGS. 4 and 5.

FIG. 7 is a perspective view of a second embodiment of an improved FOWT platform in accordance with this invention.

FIG. 8 is a top plan view of the FOWT platform illustrated in FIG. 7 shown without the wind turbine and the wind turbine tower.

FIG. 9 is an elevational view of the FOWT platform illustrated in FIGS. 7 and 8.

FIG. 10 is a perspective view of a third embodiment of an improved FOWT platform in accordance with this invention.

FIG. 11 is a top plan view of the FOWT platform illustrated in FIG. 10 shown without the wind turbine and the wind turbine tower.

FIG. 12 is an elevational view of the FOWT platform illustrated in FIGS. 10 and 11.

FIG. 13 is a perspective view of a fourth embodiment of an improved FOWT platform in accordance with this invention.

FIG. 14 is a top plan view of the FOWT platform illustrated in FIG. 13 shown without the wind turbine and the wind turbine tower.

FIG. 15 is an elevational view of the FOWT platform illustrated in FIGS. 13 and 14.

FIG. 16 is a perspective view of a fifth embodiment of an improved FOWT platform in accordance with this invention.

FIG. 17 is a top plan view of the FOWT platform illustrated in FIG. 16 shown without the wind turbine and the wind turbine tower.

FIG. 18 is an elevational view of the FOWT platform illustrated in FIGS. 16 and 17.

FIG. 19 is a perspective view of a sixth embodiment of an improved FOWT platform in accordance with this invention.

FIG. 20 is a top plan view of the FOWT platform illustrated in FIG. 16 shown without the wind turbine and the wind turbine tower.

FIG. 21 is an elevational view of the FOWT platform illustrated in FIGS. 19 and 20.

FIG. 22 is a perspective view of a seventh embodiment of an improved FOWT platform in accordance with this invention.

FIG. 23 is a top plan view of the FOWT platform illustrated in FIG. 22 shown without the wind turbine and the wind turbine tower.

FIG. 24 is an elevational view of the FOWT platform illustrated in FIGS. 22 and 23.

FIG. 25 is a perspective view of an eighth embodiment of an improved FOWT platform in accordance with this invention.

FIG. 26 is a top plan view of the FOWT platform illustrated in FIG. 25 shown without the wind turbine and the wind turbine tower.

FIG. 27 is an elevational view of the FOWT platform illustrated in FIGS. 25 and 26.

FIG. 28 is a perspective view of a ninth embodiment of an improved FOWT platform in accordance with this invention.

FIG. 29 is a top plan view of the FOWT platform illustrated in FIG. 28 shown without the wind turbine and the wind turbine tower.

FIG. 30 is an elevational view of the FOWT platform illustrated in FIGS. 28 and 29.

### DETAILED DESCRIPTION

The present invention will now be described with occasional reference to the illustrated embodiments of the invention. This invention may, however, be embodied in different forms and should not be construed as limited to the embodiments set forth herein, nor in any order of preference. Rather, these embodiments are provided so that this disclosure will be more thorough, and will convey the scope of the invention to those skilled in the art.

The embodiments of the invention disclosed below generally provide improvements to FOWT platform that include, but are not limited to, reducing the complexity, overall weight, cost, and performance, and simplifying the construction, of the FOWT platform relative to known FOWT platforms.

As used herein, the term parallel is defined as in a plane substantially parallel to the horizon. The term vertical is defined as substantially perpendicular to the plane of the horizon.

The embodiments of the improved FOWT platforms described and illustrated herein are suitable for commercial scale floating turbines with a power capacity within the range of about 6 MW to about 25 MW. The improved FOWT platforms described and illustrated herein may also be suitable for commercial scale floating turbines with a power capacity greater than about 25 MW. Advantageously, the improved FOWT platforms described and illustrated herein may be manufactured at a lower cost relative to conventional, known FOWT platforms, and are easier to construct and deploy than conventional, known FOWT platforms for a new generation of large wind turbines.

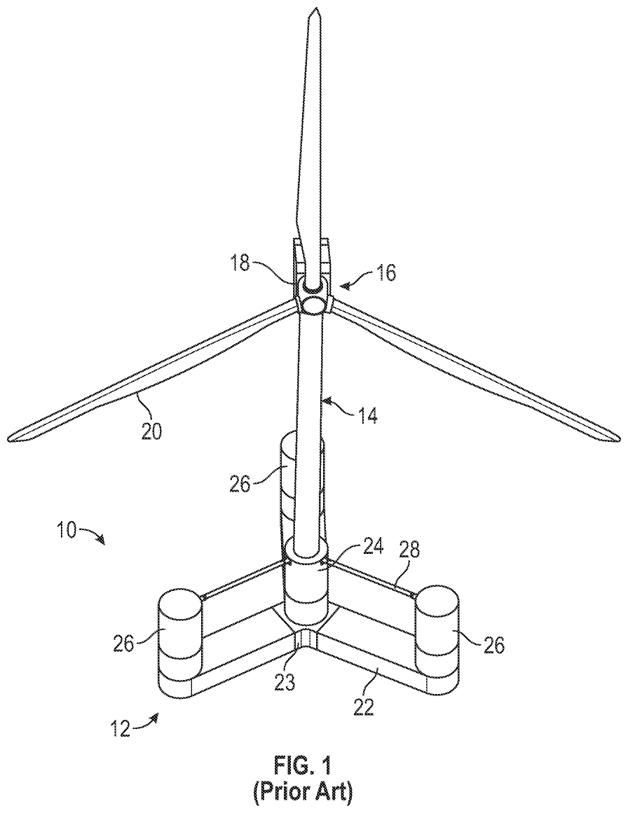

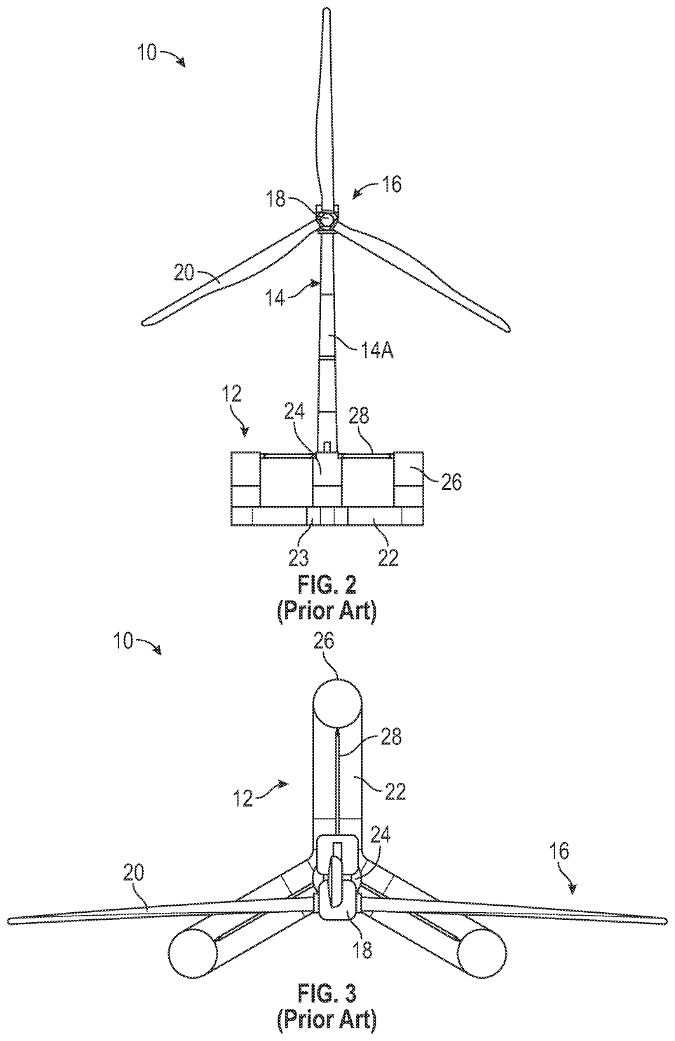

Referring to the drawings, particularly to FIG. 1, an embodiment of a known FOWT platform is shown at 10. The illustrated FOWT platform 10 includes a foundation 12 that supports a wind turbine tower 14. The wind turbine tower 14 supports a wind turbine 16. The foundation 12 is semi-submersible, and is structured and configured to float, semi-submerged, in a body of water. Accordingly, a portion of the foundation 12 will be above water when the foundation 12 is floating in the water. Mooring lines (not shown) may be attached to the FOWT platform 10 and further attached to anchors (not shown) in the seabed to limit to movement of the FOWT platform 10 on the body of water.

In the illustrated embodiment, the wind turbine tower 14 is tubular and may have any suitable outside diameter and height. In the illustrated embodiment, the outside diameter of the wind turbine tower 14 has a uniform diameter. Alternatively, the outside diameter of the wind turbine tower 14 may taper from a first diameter at its base to a second, smaller diameter at its upper end. The wind turbine tower 14 may be formed from any desired material, including but not limited to steel, concrete, fiber reinforced polymer (FRP) composite material, and a composite laminate material. If desired, the wind turbine tower 14 may be formed in any number of sections 14A.

The wind turbine 16 may be conventional and may include a rotatable hub 18. At least one rotor blade 20 is coupled to, and extends outward from, the hub 18. The hub 18 is rotatably coupled to an electric generator (not shown). The electric generator may be coupled via a transformer (not shown) and an underwater power cable (not shown) to a power grid (not shown). In the illustrated embodiment, the hub 18 has three rotor blades 20. In other embodiments, the hub 18 may have more or less than three rotor blades 20.

The illustrated foundation 12 is formed from three bottom beams 22 that extend radially outwardly from a keystone 23, connect radial or outer columns and a center column, provide heave resistance, and may provide buoyancy. An interior or center column 24 is mounted to the keystone 23, and three outer columns 26 are mounted at or near the distal ends of the bottom beams 22. The center column 24 and outer columns 26 extend upwardly and perpendicularly to the bottom beams 22 and may also provide buoyancy. Additionally, the center column 24 supports the wind turbine tower 14. Alternatively, the foundation 12 may be constructed with four bottom beams 22, each having one of the outer columns 26 mounted at or near the distal ends of each bottom beam 22.

The illustrated center column 24 and the outer columns 26 are formed from pre-stressed reinforced concrete. Alternatively, the center column 24 and the outer columns 26 may be formed from high performance concrete, FRP, steel, or combinations of pre-stressed reinforced concrete, high performance concrete, FRP, and steel. If desired, the center column 24 and the outer columns 26 may be formed in sections.

Radial support or top beams 28 are connected to the center column 24 and each of the outer columns 26, spreading the forces among the columns. The top beams 28 are configured as substantially axially loaded members and extend substantially horizontally between upper ends of the center column 24 and each outer column 26. In the illustrated embodiment, the top beams 28 are formed of tubular steel having an outside diameter of about 4 ft (1.2 m). Alternatively, the top beams 28 may be formed from FRP, pre-stressed reinforced concrete, or combinations of pre-stressed reinforced concrete, FRP, and steel.

The top beams 28 are further designed and configured substantially not to resist the bending moment of the base of the tower 14, and do not carry a bending load. Rather, the top beams 28 receive and apply tensile and compressive forces between the center column 24 and the outer columns 26.

In the embodiments illustrated herein, the wind turbine 16 is a horizontal-axis wind turbine. Alternatively, the wind turbine may be a vertical-axis wind turbine (not shown). The size of the wind turbine 16 will vary based on the wind conditions at the location where the floating wind turbine platform 10 is anchored and the desired power output. For example, the wind turbine 16 may have an output of about 5 MW. Alternatively, the wind turbine 16 may have an output within the range of from about 1 MW to about 25 MW. Additionally, if desired, the wind turbine 16 may have an output greater than about 25 MW.

The illustrated keystone 23 is formed from pre-stressed reinforced concrete, and may include an internal central cavity (not shown). Any desired process may be used to manufacture the keystone 23, such as a spun concrete process or with conventional concrete forms. Alternatively, other processes such as those used in the precast concrete industry may also be used. The concrete of the keystone 23 may be reinforced with any conventional reinforcement material, such as high tensile steel cable and high tensile steel reinforcement bars or REBAR. Alternatively, the keystone 23 may be formed from high performance concrete, FRP, steel, or combinations of pre-stressed reinforced concrete, high performance concrete, FRP, and steel.

The illustrated bottom beams 22 are formed from pre-stressed reinforced concrete as described above. Alternatively, the bottom beams 22 may be formed from high performance concrete, FRP, steel, or combinations of pre-stressed reinforced concrete, high performance concrete, FRP, and steel. The bottom beams 22 may be formed having a length within the range of about _ m to about _ m.

If desired, one or more first ballast chambers (not shown) may be formed in each bottom beam 22. Also, one or more second ballast chambers (not shown) may be formed in each outer column 26.

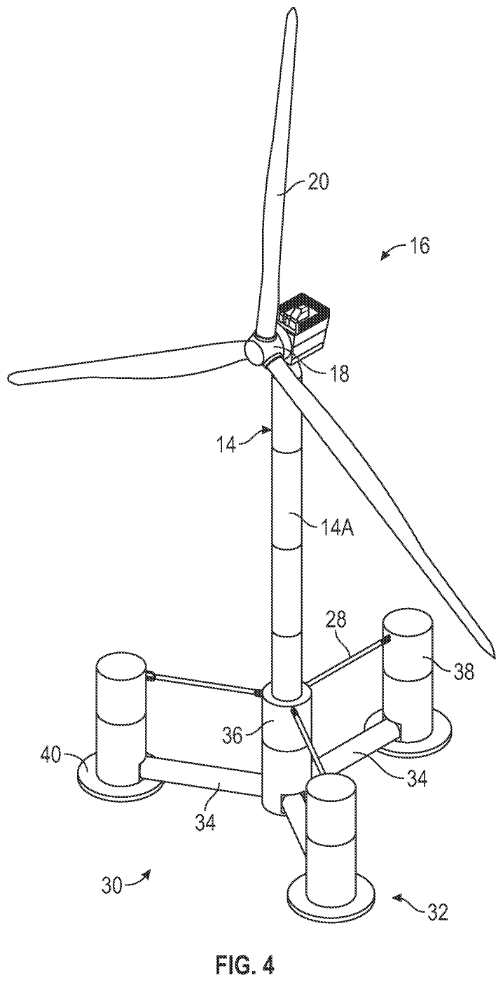

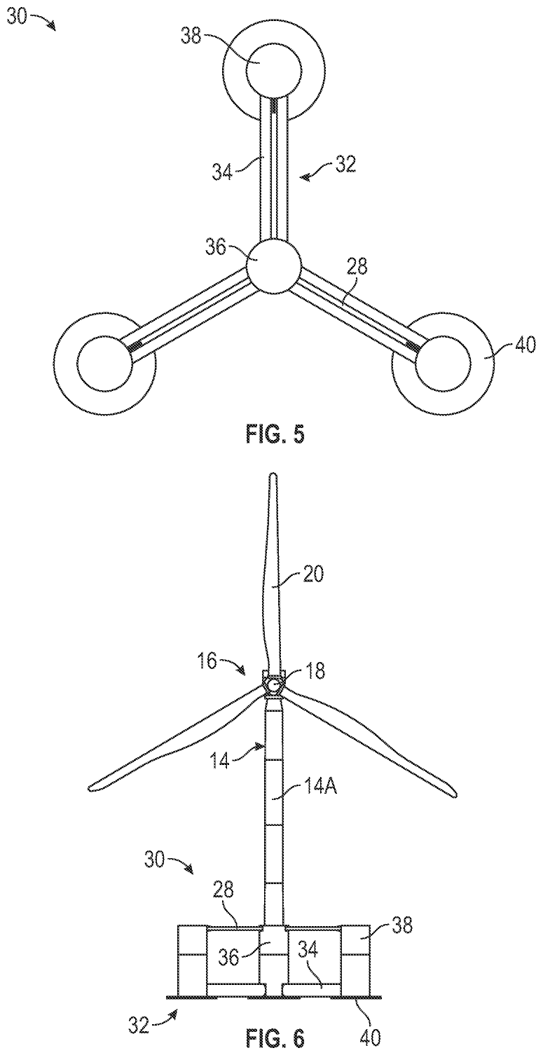

Referring now to FIGS. 4 through 6, a first embodiment of an improved FOWT platform according to this invention is shown at 30. The illustrated FOWT platform 30 includes the wind turbine tower 14 and the wind turbine 16 as described above. The illustrated FOWT platform 30 includes a foundation 32.

The illustrated foundation 32 is formed from three bottom beams 34 configured as steel tubes that extend radially outwardly from a lower portion of a center column 36, rather than a keystone, connect the radial or outer columns and a center column, provide heave resistance, and provide buoyancy. Three outer columns 38 are mounted at or near the distal ends of the bottom beams 34. The center column 36 and outer columns 38 extend upwardly and perpendicularly to the bottom beams 34 and also provide buoyancy. Additionally, the center column 36 supports the wind turbine tower 14. The foundation 32 includes the top beams 28 that are connected to the center column 36 and each of the outer columns 38. Disk-shaped heave plates 40 may be attached to a base portion of each of the outer columns 38. The center column 36 and the outer columns 38 may be formed and configured in the same manner as described above regarding the center column 24 and the outer columns 26. Also, if desired, the foundation 32 may be constructed with four bottom beams 34, each having one of the outer columns 26 mounted at or near the distal ends of each bottom beam 34.

It will be understood that a diameter of the tubular bottom beams 34 may be determined based on a size of the wind turbine 16 to be mounted on the wind turbine tower 14, and the environmental conditions. Advantageously, the tubular bottom beams 34 may be formed from sections of the tubular material similar to those used to form the wind turbine tower 14, and/or the tubular bottom beams 34 may be formed using similar manufacturing equipment used to form the wind turbine tower 14. The tubular bottom beams 34 are configured to substantially carry the bending, shear, and torsion forces between the center column 36 and the radially arranged outer columns 38.

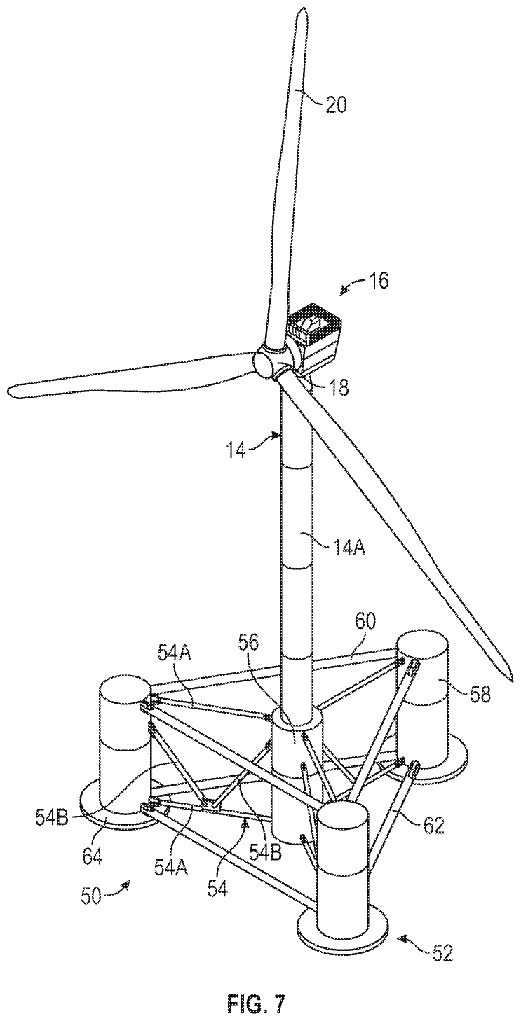

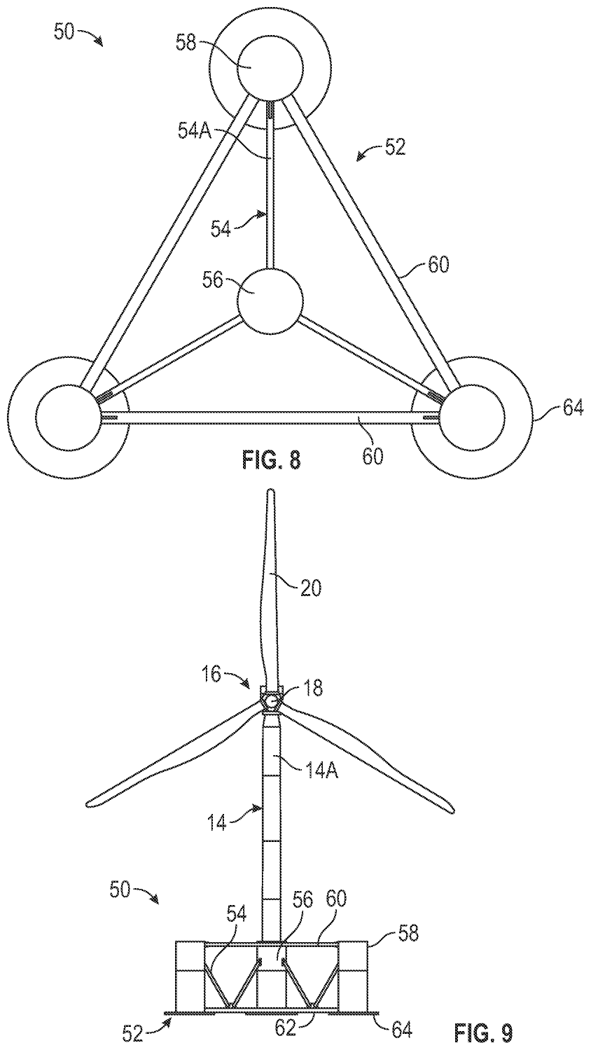

Referring now to FIGS. 7 through 10, a second embodiment of an improved FOWT platform according to this invention is shown at 50. The illustrated FOWT platform 50 includes the wind turbine tower 14 and the wind turbine 16 as described above. The illustrated FOWT platform 50 includes a foundation 52.

The illustrated foundation 52 includes a center column and three trusses 54 that extend radially outwardly from the center column 56 to each of three outer columns 58. The illustrated trusses 54 include an elongated first truss member 54A that extends between a base of the center column 56 and a base of each outer column 58. Each truss 54 further includes a pair of second truss members 54B. One of the second truss members 54B extends between a mid-point of the first truss member 54A and the center column 56 and a second one of the second truss members 54B extends between the mid-point of the first truss member 54A and one of the outer columns 58. Three additional first truss members 54A extend between the center column 56 and each of the outer columns 58. The trusses 54, including the first and second truss members 54A and 54B, may be formed from steel, such as steel tube.

Top support beams 60 extend between the outer columns 58. Similarly, bottom support beams 62 also extend between the outer columns 58. In the illustrated embodiment, the trusses 54 are formed from steel. The top and bottom support beams 60 and 62, respectively, are formed from steel tube.

The center column 56 and outer columns 58 extend upwardly and perpendicularly to the top and bottom support beams 60 and 62, respectively. Additionally, the center column 56 supports the wind turbine tower 14. Disk-shaped heave plates 64 may be attached to a base portion of each of the outer columns 58.

The steel trusses 54 are configured to carry the bending, shear, and torsion forces between the center column 56 and the radially arranged outer columns 58. The top and bottom steel support beams 60 and 62, respectively, are configured to provide torsional support for the outer columns 58.

Also, if desired, the foundation 52 may be constructed with four outer columns 58, wherein each outer column 58 is connected to an adjacent outer column 58 by the top support beams 60 and the bottom support beams 62, and to the center column 56 by one of the trusses 54, described above.

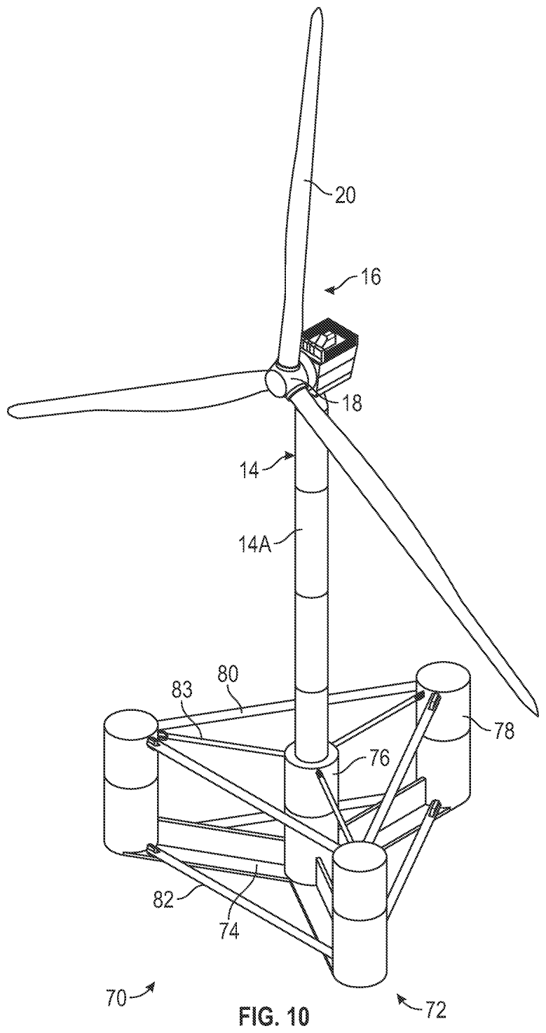

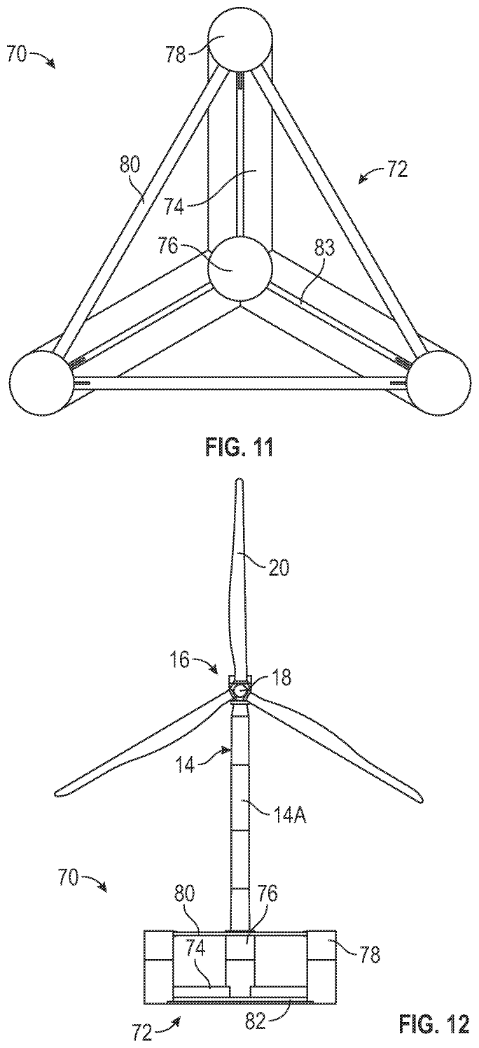

Referring now to FIGS. 10 through 12, a third embodiment of an improved FOWT platform according to this invention is shown at 70. The illustrated FOWT platform 70 includes the wind turbine tower 14 and the wind turbine 16 as described above. The illustrated FOWT platform 70 includes a foundation 72.

The illustrated foundation 72 is formed from three bottom T-beams 74 that extend radially outwardly from center column 76. The illustrated T-beams 74 are formed from pre-stressed reinforced concrete as described above. Alternatively, the bottom T-beams 74 may be formed from FRP, steel, or combinations of pre-stressed reinforced concrete, FRP, and steel.

Three outer columns 78 are mounted at or near the distal ends of the bottom T-beams 74. The center column 76 and outer columns 78 extend upwardly and perpendicularly to the bottom T-beams 74 and also provide buoyancy. Additionally, the center column 76 supports the wind turbine tower 14. Top support beams 80 extend between the outer columns 76. Similarly, bottom support beams 82 also extend between the outer columns 76. Radially extending top beams 83 are connected to the center column 76 and each of the outer columns 78. In the illustrated embodiment, the top and bottom support beams 80 and 82, and the radially extending top beams 83 are formed from steel tube.

The center column 76 and outer columns 78 extend upwardly and perpendicularly to the top and bottom support beams 80 and 22, respectively.

The bottom T-beams 74 are configured to carry the bending and shear forces between the center column 76 and the radially arranged outer columns 78. The top and bottom steel support beams 80 and 82 are configured to provide torsional support for the outer columns 78. This embodiment of the FOWT platform 70 does not require heave plates, such as the heave plates 40 or 64, although heave plates may be provided.

Also, if desired, the foundation 72 may be constructed with four bottom T-beams 74, each having one of the outer columns 78 mounted at or near the distal ends of each bottom T-beams 74.

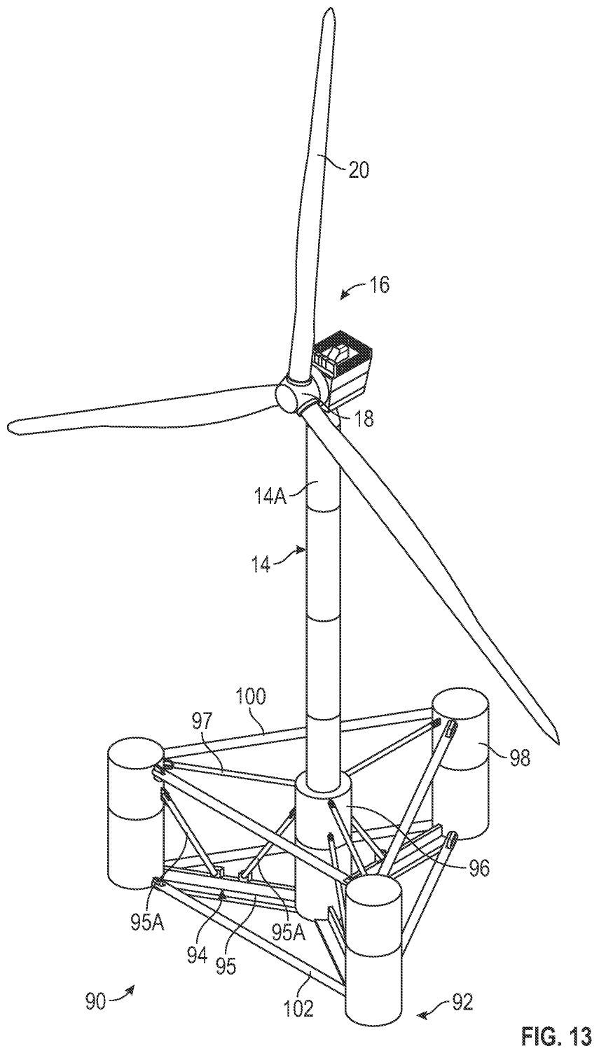

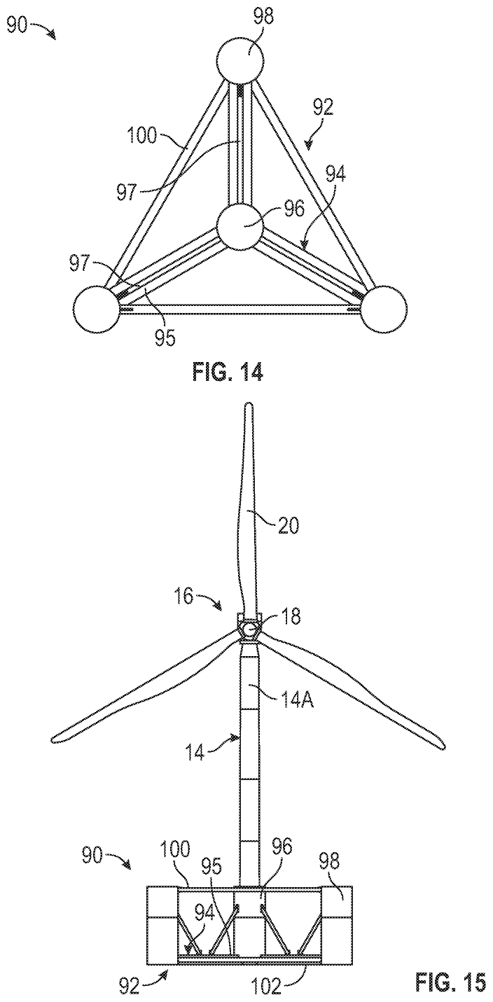

Referring now to FIGS. 13 through 15, a fourth embodiment of an improved FOWT platform according to this invention is shown at 90. The illustrated FOWT platform 90 includes the wind turbine tower 14 and the wind turbine 16 as described above. The illustrated FOWT platform 90 includes a foundation 92.

The illustrated foundation 92 includes a center column 96 and three trusses 94 that extend radially outwardly from the center column 96 to each of three outer columns 98. In the illustrated embodiment, the trusses 94 are a hybrid concrete-steel construction wherein a first truss member or bottom chord is formed as a prestressed reinforced concrete T-beam 95. Each T-beam 95 extends between a base of the center column 96 and a base of each outer column 98. Each truss 94 further includes a pair of second truss members 95A. One of the second truss members 95A extends between a mid-point of the T-beam 95 and the center column 96 and a second one of the second truss members 95A extends between the mid-point of the T-beam 95 and one of the outer columns 98. Three third truss members 97 extend radially between the center column 96 and each of the outer columns 98. The second truss members 95A and the third truss members 97, may be formed from steel, such as steel tube.

Top support beams 100 extend between the outer columns 96. Similarly, bottom support beams 102 also extend between the outer columns 96. In the illustrated embodiment, the second truss members 95A and the third truss members 97 are formed from steel. The top and bottom support beams 100 and 102, respectively, are formed from steel tube.

The center column 96 and outer columns 98 extend upwardly and perpendicularly to the top and bottom support beams 100 and 102, respectively. Additionally, the center column 96 supports the wind turbine tower 14.

The hybrid concrete-steel trusses 94 are configured to carry the bending and shear forces between the center column 96 and the radially arranged outer columns 98. The top and bottom steel support beams 100 and 102 are configured to provide torsional support for the outer columns 98. This embodiment of the FOWT platform 90 may be provided with heave plates, such as the heave plates 40 or 64.

The embodiments of the FOWT platforms 30, 50, 70, and 90, illustrated in FIGS. 4 through 15, provide several advantages relative to conventional, known FOWT platforms in certain manufacturing environments. The advantages include, but are not limited to: a lighter component weight due to the elimination of a concrete keystone and concrete box beams, the steel components, such as the tubular bottom beams 34, the use of turbine tower shapes that are commonly produced in the wind energy industry to reduce cost, features such as heave plates and T-beams provide efficient added mass to the FOWT platforms to minimize dynamic motions during storms, and many components are smaller than similar components in conventional, known FOWT platforms due to reduced mass and structural loading. Additionally, the center and outer columns are formed from concrete, and the bracing members are formed from either steel or concrete as described above.

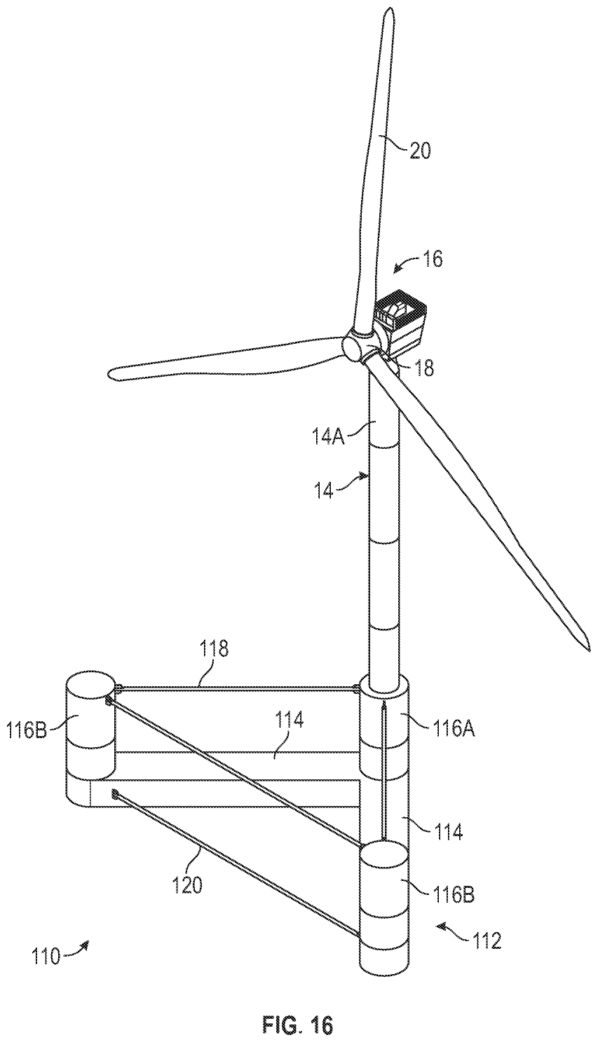

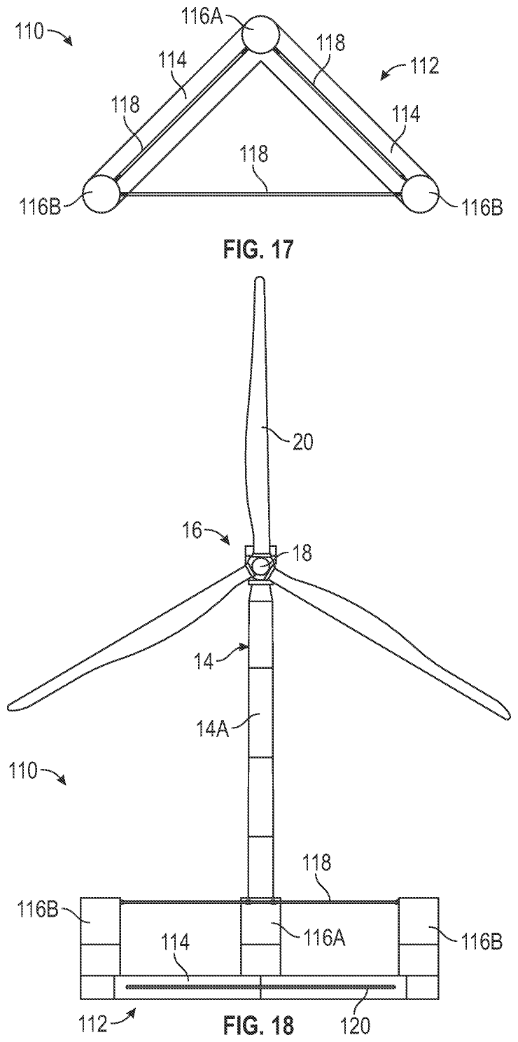

Referring now to FIGS. 16 through 18, a fifth embodiment of an improved FOWT platform according this invention is shown at 110. The illustrated FOWT platform 110 includes the wind turbine tower 14 and the wind turbine 16 as described above. The illustrated FOWT platform 110 includes a foundation 112.

The foundation 112 is formed from two elongated buoyant bottom beams 114 that are similar to, but longer than, the bottom beams 22 shown in FIG. 1. For example, the bottom beams 114 may have a length within the range of about _ m to about _ m. Additionally, the bottom beams 114 may be formed in the same manner as the bottom beams 22 described above. The bottom beams 114 are connected together at an angle of about 90 degrees. A first column 116A is mounted to the two connected bottom beams 114 at the vertex defined thereby. Two additional or outer columns 116B are mounted at or near the distal ends of the bottom beams 114. The outer columns 116B extend upwardly and perpendicularly to the bottom beams 114 and also provide buoyancy. Additionally, the first column 116A mounted at the vertex of the two bottom beams 114 supports the wind turbine tower 14.

Top support beams 118 extend between the three columns 116A and 116B. Similarly, a bottom support beam 120 also extends between the distal ends of the bottom beams 114. Thus, the top and bottom support beams 118 and 120, respectively, brace the top and bottom of the outer columns 116. In the illustrated embodiment, the top and bottom support beams 118 and 120 are formed from steel tube.

The longer bottom beams 114 are configured to carry the bending, shear, and torsion forces between the vertex of the connect3ed bottom beams 114 and the outer columns 116B, and provide additional buoyancy and heave resistance. The top and bottom steel support beams 118 and 120 are also configured to provide torsional support for the outer columns 116B.

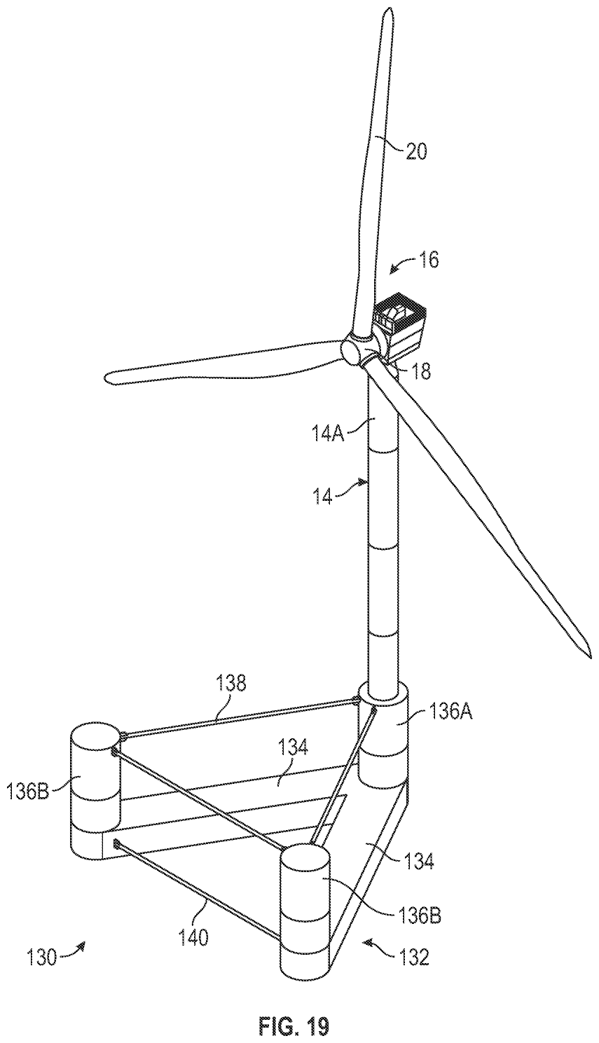

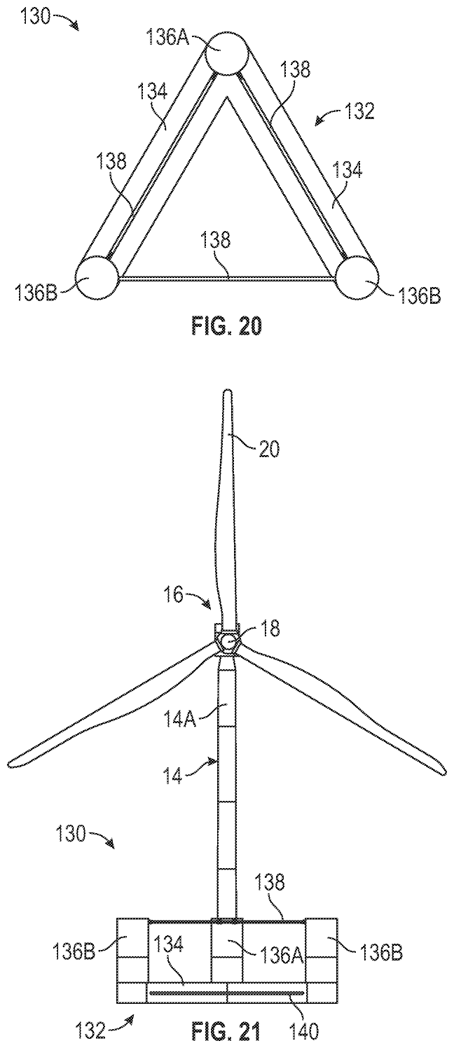

Referring now to FIGS. 19 through 21, a sixth embodiment of an improved FOWT platform according this invention is shown at 130. The illustrated FOWT platform 130 includes the wind turbine tower 14 and the wind turbine 16 as described above. The illustrated FOWT platform 130 includes a foundation 132. The FOWT platform 130 is similar to the FOWT platform 110 except that elongated buoyant bottom beams 134 are connected together at a 60 degree angle.

Thus, the foundation 132 is formed from the two bottom beams 134 that are similar to, but may have a different length than, the bottom beams 114 shown in FIGS. 16 through 18. Like the bottom beams 114, the bottom beams 134 may be formed in the same manner as the bottom beams 22 described above, and may have a length within the range of about _ m to about _ m. The bottom beams 134 are connected together at a 60 degree angle. A first column 136A is mounted to the two connected bottom beams 134 at the vertex defined thereby. Two additional or outer columns 136B are mounted at or near the distal ends of the bottom beams 134. The outer columns 136B extend upwardly and perpendicularly to the bottom beams 134 and also provide buoyancy. Additionally, the first column 136A mounted at the vertex of the two bottom beams 134 supports the wind turbine tower 14.

Top support beams 138 extend between the three columns 136A and 136B. Similarly, a bottom support beam 140 also extends between the distal ends of the bottom beams 134. Thus, the top and bottom support beams 138 and 140, respectively, brace the top and bottom of the outer columns 136B. In the illustrated embodiment, the top and bottom support beams 138 and 140 are formed from steel tube.

The bottom beams 134 are configured to carry the bending, shear, and torsion forces between the vertex of the connected bottom beams 134 and the outer columns 136B. The top and bottom steel support beams 138 and 140 are also configured to provide torsional support for the outer columns 136B.

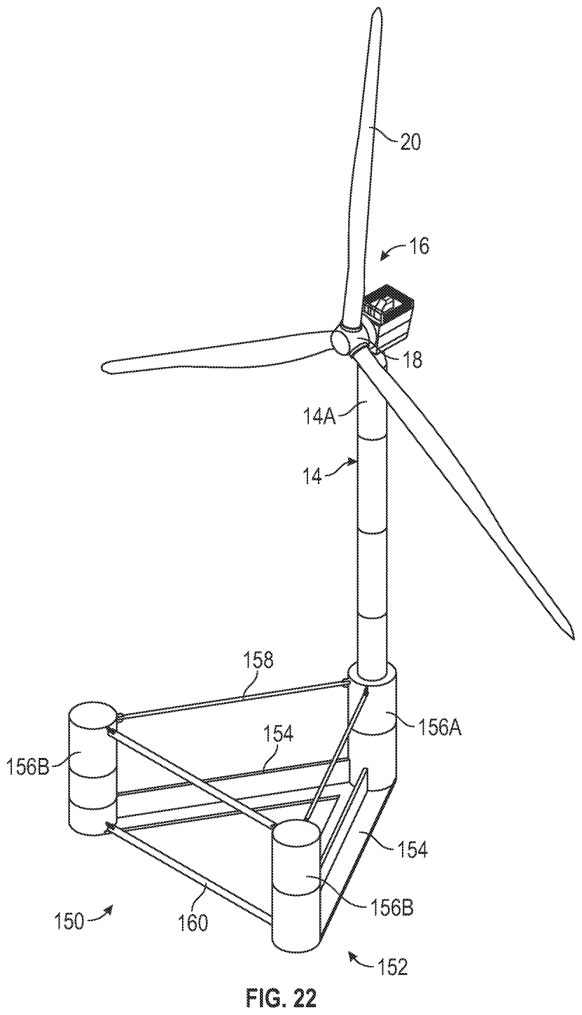

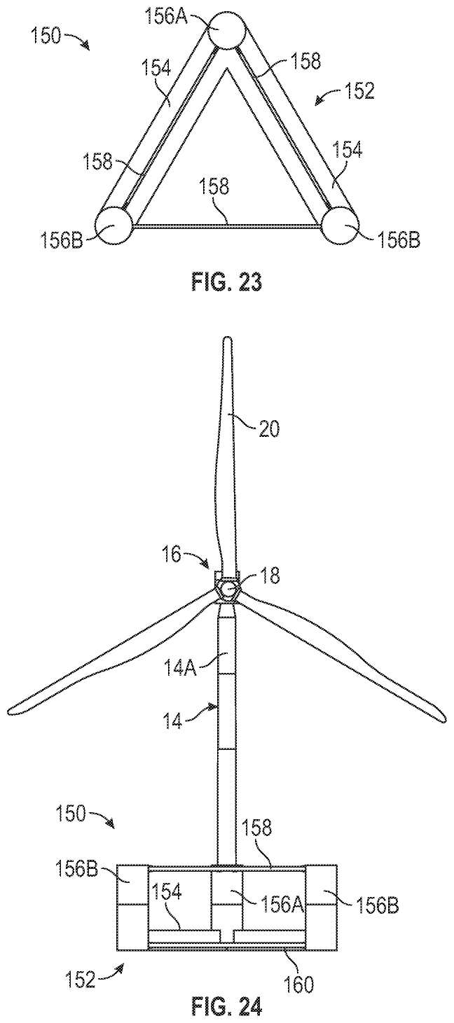

Referring now to FIGS. 22 through 24, a seventh embodiment of an improved FOWT platform according this invention is shown at 150. The illustrated FOWT platform 150 includes the wind turbine tower 14 and the wind turbine 16 as described above. The illustrated FOWT platform 150 includes a foundation 152. The FOWT platform 150 is similar to the FOWT platform 130 except that bottom beams are formed as prestressed reinforced concrete T-beams 154, as described above.

Thus, the foundation 152 is formed from two of the T-beams 154 that are connected together at a 60-degree angle. A first column 156A is mounted to the two connected bottom beams 154 at the vertex defined thereby. Two additional or outer columns 156B are mounted at or near the distal ends of the T-beams 154. The outer columns 156B extend upwardly and perpendicularly to the T-beams 154 and also provide buoyancy. Additionally, the first column 156A mounted at the vertex of the two T-beams 154 supports the wind turbine tower 14. The T-beams 154 may have a length within the range of about _ m to about _ m. If desired, the foundation 152 may be formed from two of the T-beams 154 that are connected together at a 90-degree angle.

Top support beams 158 extend between the three columns 156A and 156B. Similarly, a bottom support beam 160 also extends between the distal ends of the T-beams 154. Thus, the top and bottom support beams 158 and 160, respectively, brace the top and bottom of the outer columns 156B. In the illustrated embodiment, the top and bottom support beams 158 and 160 are formed from steel tube.

The T-beams 154 are configured to carry the bending, shear, and some torsion forces between the first column 156A (at the vertex of the connected T-beams 154) and the outer columns 156B. The top and bottom steel support beams 158 and 160 are also configured to provide torsional support for the outer columns 156B.

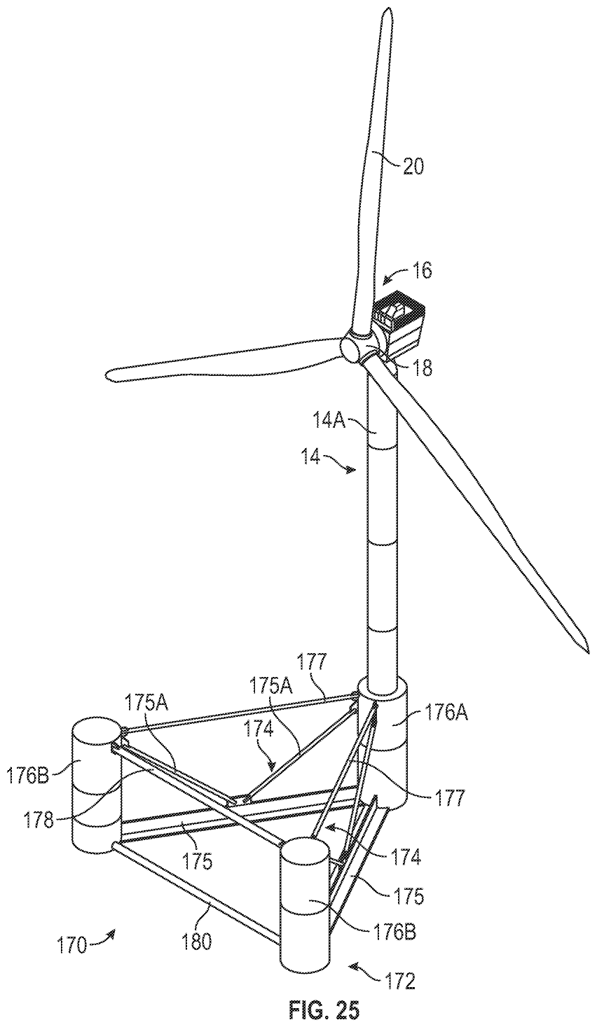

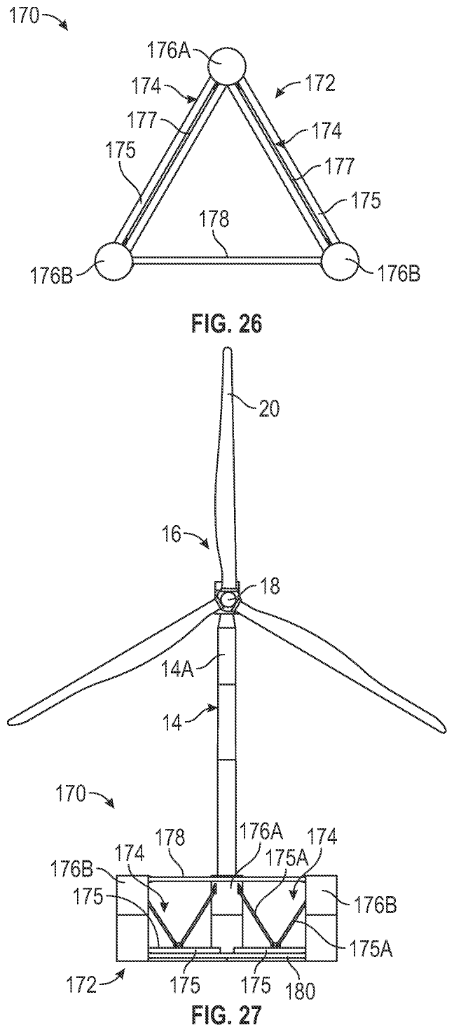

Referring now to FIGS. 25 through 27, an eighth embodiment of an improved FOWT platform according this invention is shown at 170. The illustrated FOWT platform 170 includes the wind turbine tower 14 and the wind turbine 16 as described above. The illustrated FOWT platform 170 includes a foundation 172.

The foundation 172 includes two trusses 174 that extend outwardly from a first of three columns 176A to each of a second and third, or outer columns 176B. A top support beam 178 extends between the two outer columns 176B. Similarly, a bottom support beam 180 also extends between the outer columns 176B. In the illustrated embodiment, the trusses 174 are a hybrid concrete-steel construction wherein a first truss member or bottom chord is formed as a prestressed reinforced concrete T-beam 175. The top and bottom support beams 178 and 180 are formed from steel tube.

The illustrated foundation 172 is formed from two of the trusses 174 that are connected together at a 60-degree angle. If desired, the foundation 172 may be formed from two of the trusses 174 that are connected together at a 90-degree angle.

Each truss 174 further includes a pair of second truss members 175A. One of the second truss members 175A extends between a mid-point of the T-beam 175 and the first column 176A, and a second one of the second truss members 175A extends between the mid-point of the T-beam 175 and one of the outer columns 176B. Two third truss members 177 extend between the first column 176A and each of the outer columns 176B. The second truss members 175A and the third truss members 177 may be formed from steel, such as steel tube.

The hybrid concrete-steel trusses 174 are configured to carry the bending and shear forces between a lower end of the first column 176A and the outer columns 176B. The top and bottom steel support beams 178 and 180, and the trusses 174, including the concrete T-beams 175, are configured to provide torsional support for the outer columns 176B.

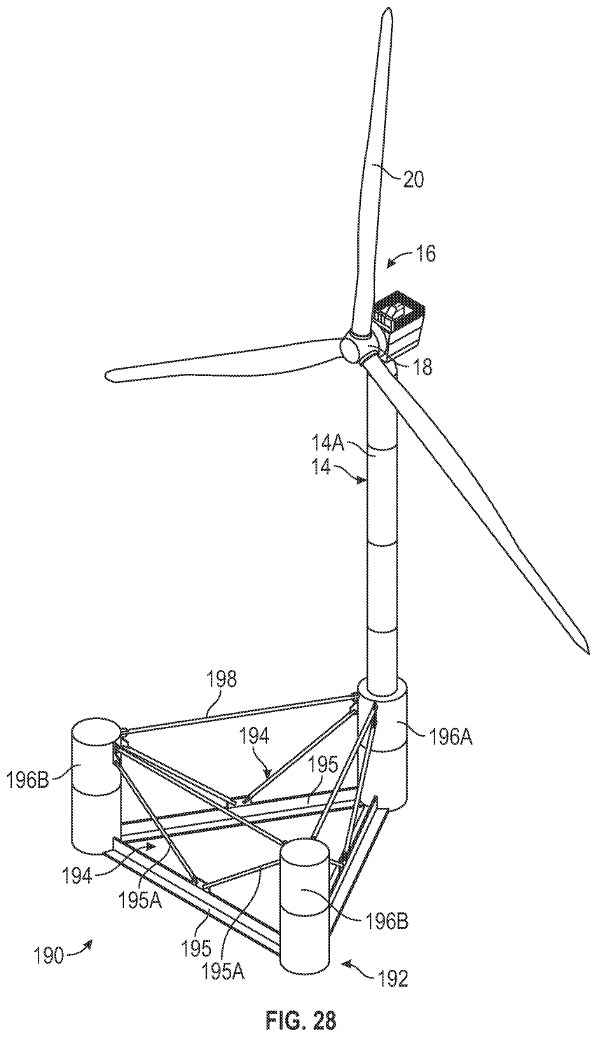

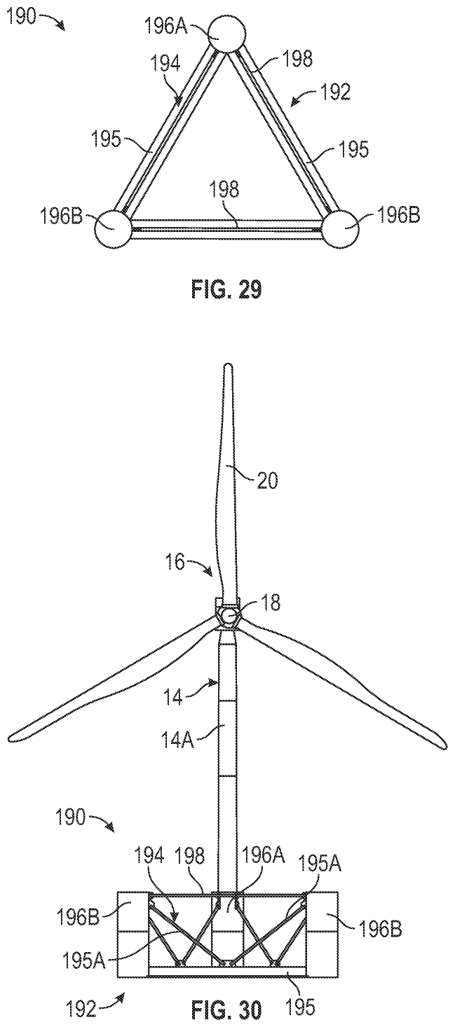

Referring now to FIGS. 28 through 30, a ninth embodiment of an improved FOWT platform according this invention is shown at 190. The illustrated FOWT platform 190 includes the wind turbine tower 14 and the wind turbine 16 as described above. The illustrated FOWT platform 190 includes a foundation 192. The FOWT platform 190 is similar to the FOWT platform 170 except that the FOWT platform 190 includes three trusses 194.

Thus, the foundation 192 is formed from the three trusses 194 that extend between each of three columns, including a first column 196A and two outer columns 196B. In the illustrated embodiment, the trusses 194 are a hybrid concrete-steel construction wherein a first truss member or bottom chord is formed as a prestressed reinforced concrete T-beam 195.

Each truss 194 further includes a pair of second truss members 195A. One of the second truss members 195A extends between a mid-point of the T-beam 195 and one of the columns 196A or 196B, and a second one of the second truss members 195A extends between the mid-point of the T-beam 195 and an adjacent one of the columns 196A or 196B. Third truss members 198 also extend between each of the columns 196A and 196B. The second truss members 195A and the third truss members 198 may be formed from steel, such as steel tube.

The illustrated foundation 192 is formed wherein each of the trusses 194 are connected together at a 60-degree angle. If desired, the foundation 192 may be formed wherein the trusses 194 connected at the first column 196A are connected at a 90-degree angle.

The hybrid concrete-steel trusses 194 are configured to carry the bending and shear forces between lower ends of the connected columns 196A and 196B. The third truss members 198, and the trusses 194, including concrete T-beams 195, are configured to provide torsional support for the first and outer columns 196A and 196B, respectively.

The embodiments of the FOWT platforms 110, 130, 150, 170, and 190, illustrated in FIGS. 16 through 30, have several advantages relative to conventional, known FOWT platforms. The advantages include, but are not limited to: a reduced number of components, e.g. having three columns and two bottom beams or bottom support beams, a structure that allows for cranes to access more closely the column supporting the turbine to minimize crane requirements, reduced complexity of the connections between components, a 90 degree design option (see, for example, FIGS. 16 through 18) that may be easier to fabricate, a 60 degree design option (see, for example, FIGS. 19 through 21) that improves efficiency, and the option of manufacturing the embodiments shown in FIGS. 22 through 30 with a 90 degree angle between lower beams.

The principle and mode of operation of the invention have been described in its preferred embodiments. However, it should be noted that the invention described herein may be practiced otherwise than as specifically illustrated and described without departing from its scope.

What is claimed is:

1. A semi-submersible wind turbine platform capable of floating on a body of water and supporting a wind turbine, the semi-submersible wind turbine platform comprising:
a center column;
at least three tubular bottom beams extending radially outward of a first axial end of the center column, the center column configured to have a tower attached to a second axial end thereof;
outer columns, wherein a first axial end of each outer column attached to a distal end of one of the bottom beams; and
top beams, one of which extends between a second axial end of each outer column and the second axial end of the center column.

2. The semi-submersible wind turbine platform according to claim 1, wherein the outer and central columns are made of prestressed concrete, and wherein the outer columns have disk-shaped heave plates mounted to the first axial ends thereof, the heave plates extending radially beyond a perimeter of the outer columns.

3. The semi-submersible wind turbine platform according to claim 2, wherein the tubular bottom beams are formed from one of steel, steel tube, concrete, fiber reinforced polymer (FRP) composite material, and a composite laminate material.

4. A semi-submersible wind turbine platform capable of floating on a body of water and supporting a wind turbine, the semi-submersible wind turbine platform comprising:
a center column having a first axial end and a second axial end, the center column configured to have a tower attached to the second axial end thereof;
at least three outer columns having first and second axial ends;
a plurality of trusses, wherein each truss extends radially outward of the center column to one of the outer columns;
top support beams extending between each outer column; and
bottom support beams extending between each outer column.

5. The semi-submersible wind turbine platform according to claim 4, wherein the outer and center columns are made of prestressed reinforced concrete, and wherein the outer columns have disk-shaped heave plates mounted to the first axial ends thereof, the heave plates extending radially beyond a perimeter of the outer columns.

6. The semi-submersible wind turbine platform according to claim 4, wherein each truss further includes:
a plurality of elongated first truss members, wherein one of the first truss members extends between a base of the center column and a base of each outer column, and wherein three of the first truss members extend between the center column and each of the outer columns; and
a pair of second truss members, wherein one of the second truss members extends between a mid-point of the first truss member and the center column, and a second one of the second truss members extends between the mid-point of the first truss member and one of the outer columns.

7. A semi-submersible wind turbine platform capable of floating on a body of water and supporting a wind turbine, the semi-submersible wind turbine platform comprising:
a center column having a first axial end and a second axial end, the center column configured to have a tower attached to the second axial end thereof;
at least three outer columns having first and second axial ends;
at least three bottom T-beams extending radially outward of the center column to the outer columns, wherein the bottom beams are formed from prestressed reinforced concrete;
at least three radially extending top beams connected to the center column and to each of the outer columns;
three top support beams, one of which extends between each of two adjacent outer columns; and
at least three bottom support beams, one of which extends between each of two adjacent outer columns.

8. The semi-submersible wind turbine platform according to claim 7, wherein the bottom T-beams are formed from one of pre-stressed reinforced concrete, FRP, steel, and combinations of pre-stressed reinforced concrete, FRP, and steel.

9. The semi-submersible wind turbine platform according to claim 7, wherein the outer and central columns are made of prestressed reinforced concrete, and wherein the top and bottom support beams, and the radially extending top beams are formed from steel tube.

10. A semi-submersible wind turbine platform capable of floating on a body of water and supporting a wind turbine, the semi-submersible wind turbine platform comprising:
a center column having a first axial end and a second axial end, the center column configured to have a tower attached to the second axial end thereof;
at least three outer columns having first and second axial ends;
at least three trusses extending radially outward of the center column to the outer columns, wherein the trusses are hybrid concrete-steel trusses, and wherein each truss includes a bottom truss chord formed as a pre-stressed reinforced concrete T-beam;
a plurality of top support beams, one of which extends between each of two adjacent outer columns; and
a plurality of bottom support beams, one of which extends between each of two adjacent outer columns.

11. The semi-submersible wind turbine platform according to claim 10, wherein each truss further includes:
a pair of second truss members, wherein one of the second truss members extends between a mid-point of the T-beam and the center column, and a second one of the second truss members extends between the mid-point of the T-beam and one of the outer columns; and
a third truss member that extends radially between the center column and one of the outer columns.

12. The semi-submersible wind turbine platform according to claim 10, wherein the outer and center columns are made of prestressed reinforced concrete, and wherein the top and bottom support beams are formed from steel tube.

13. A semi-submersible wind turbine platform capable of floating on a body of water and supporting a wind turbine, the semi-submersible wind turbine platform comprising:
two elongated buoyant bottom beams connected at an angle of about 90 degrees and defining a vertex;
a first column extending perpendicularly from the bottom beams at the vertex thereof, a first axial end of the first column attached to the bottom beams, the first column configured to have a tower attached to a second axial end thereof;
two outer columns, one of which is attached to a distal end of each bottom beam;
three top support beams, one of which extends between each of two adjacent columns; and
a bottom support beam extending between the two outer columns.

14. The semi-submersible wind turbine platform according to claim 13, wherein the first and outer columns are made of prestressed reinforced concrete, wherein the two bottom beams are rectangular prestressed concrete beams; and wherein the top and bottom support beams are formed from steel tube.

15. A semi-submersible wind turbine platform capable of floating on a body of water and supporting a wind turbine, the semi-submersible wind turbine platform comprising:
two elongated buoyant bottom beams connected at an angle of about 60 degrees and defining a vertex;
a first column extending perpendicularly from the bottom beams at the vertex thereof, a first axial end of the first column attached to the bottom beams, the first column configured to have a tower attached to a second axial end thereof;
two outer columns, one of which is attached to a distal end of each bottom beam;
three top support beams, one of which extends between each of two adjacent columns; and
a bottom support beam extending between the two outer columns.

16. The semi-submersible wind turbine platform according to claim 15, wherein the first and outer columns are made of prestressed reinforced concrete, wherein the two bottom beams are rectangular prestressed concrete beams, and wherein the top and bottom support beams are formed from steel tube.

17. A semi-submersible wind turbine platform capable of floating on a body of water and supporting a wind turbine, the semi-submersible wind turbine platform comprising:
two elongated bottom beams connected at an angle of about 60 degrees and defining a vertex, wherein the bottom beams are formed as prestressed reinforced concrete T-beams;
a first column extending perpendicularly from the bottom beams at the vertex thereof, a first axial end of the first column attached to the bottom beams, the first column configured to have a tower attached to a second axial end thereof;
two outer columns attached to a distal end of each bottom beam;
three top support beams, one of which extends between each of two adjacent columns; and
a bottom support beam extending between the two outer columns.

18. The semi-submersible wind turbine platform according to claim 17, wherein the first and outer columns are made of prestressed reinforced concrete, wherein the two bottom beams are rectangular prestressed concrete beams, and wherein the top and bottom support beams are formed from steel tube.

19. A semi-submersible wind turbine platform capable of floating on a body of water and supporting a wind turbine, the semi-submersible wind turbine platform comprising:
a first column having a first axial end and a second axial end, wherein the first column is configured to have a tower attached to the second axial end thereof;
two outer columns, each outer column having a first axial end and a second axial end;
two trusses extending radially outward of the first column to the outer columns at a 60 degree angle and defining a vertex, wherein the trusses are hybrid concrete-steel trusses, and wherein each truss includes a bottom truss chord formed as a prestressed reinforced concrete T-beam;
wherein the first column is attached to the two trusses at the vertex thereof; and
wherein a distal end of each truss is attached to one of the two outer columns;
a top support beam extending between the two outer columns; and
a bottom support beam extending between the two outer columns.

20. The semi-submersible wind turbine platform according to claim 19, wherein the first and outer columns are made of one of prestressed reinforced concrete and high performance concrete, and wherein the top and bottom support beams are formed from steel tube.

21. The semi-submersible wind turbine platform according to claim 19, wherein each truss further includes:
a pair of second truss members, wherein one of the second truss members extends between a mid-point of the T-beam and the first column, and a second one of the second truss members extends between the mid-point of the T-beam and one of the outer columns; and
a third truss member that extends radially between the first column and one of the outer columns.

22. A semi-submersible wind turbine platform capable of floating on a body of water and supporting a wind turbine, the semi-submersible wind turbine platform comprising:
a first column having a first axial end and a second axial end, wherein the first column is configured to have a tower attached to the second axial end thereof;
two outer columns, each outer column having a first axial end and a second axial end; and
three trusses;
wherein two of the trusses extend radially outward of the first column to each of the outer columns at a 60 degree angle and define a vertex;
wherein the first column is attached to the two trusses at the vertex thereof;
wherein the distal ends of the two trusses are attached to the outer columns;
wherein a third one of the trusses extends between the two outer columns and is attached to the two outer columns;
wherein the trusses are hybrid concrete-steel trusses; and
wherein each truss includes a bottom truss chord formed as a prestressed reinforced concrete T-beam.

23. The semi-submersible wind turbine platform according to claim 22, wherein the first and outer columns are made of one of prestressed reinforced concrete and high performance concrete.

24. The semi-submersible wind turbine platform according to claim 22, wherein each truss further includes:
a pair of second truss members, wherein one of the second truss members extends between a mid-point of the T-beam and one of the first and outer columns, and a second one of the second truss members extends between the mid-point of the T-beam and an adjacent one of the first and outer columns; and
a third truss member that extends between the one of the first and outer columns and the adjacent one of the first and outer columns and is parallel with the T-beam.
